(19) United States
(12) Patent Application Publication
(10) Pub. No.: US 2023/0337625 A1
(43) Pub. Date: Oct. 26, 2023

(54) SYSTEM AND METHOD FOR ACTIVITY MONITORING OF ANIMALS IN HOMECAGES

(71) Applicant: GOVERNMENT OF ISRAEL – THE ISRAEL INSTITUTE FOR BIOLOGICAL RESEARCH (IIBR), NESS ZIONA (IL)

(72) Inventors: YARON VAGIMA, MODIIN-MACABIM-REUT (IL); SHLOMY MAIMON, GIV'ATAYIM (IL); EFI YITZHAK, ASHDOD (IL)

(21) Appl. No.: 17/799,947

(22) PCT Filed: Feb. 16, 2021
(86) PCT No.: PCT/IB2021/051296

§ 371 Date: Aug. 16, 2022

Related U.S. Application Data
(60) Provisional application No. 62/977,333, filed on Feb. 16, 2020.

(51) Int. Cl. A01K 1/03; G01V 8/20

(52) U.S. Cl. CPC A01K 1/031; G01V 8/20

(57) ABSTRACT

A homecage monitoring system including: a detection assembly including: a single detector including a retroreflective-sensor; a mounting assembly configured for mounting of the single detector thereto and for attachment of the mounting assembly to a cage rack adjacent to a homecage to be monitored; and a controller in data communication with the single detector and adapted for collecting the output data from the single detector.

### FIELD

Embodiments disclosed herein relate to systems and methods for monitoring of animals in laboratory environments where the animals are housed in homecages.

### BACKGROUND

Experimental research with animals is usually conducted in laboratories where the animals are housed for observation. Examples of applied research conducted on animals include testing disease treatments, disease reactions, breeding, defense research and toxicology. As part of the research it is necessary to evaluate the reaction or health of the animal to the test being performed. Thus, ongoing animal monitoring/observation is performed as part of the animal-based research.

Animals are usually housed for observation in “homecages” under defined conditions related to the research that the animals are part of. These cages may or may not be separated from the surrounding environment for providing a home to the animals. A typical homecage and cage rack arrangement is illustrated in FIGS. 1A-1F. Homecages 22 and cage racks 20 have roughly standard dimensions per animal type and are typically acquired by the research facility from a cage manufacturer. A non-limiting example of an industry standard homecage is the Tecniplast® GM500 homecage and a non-limiting example of an industry standard cage rack is the Tecniplast® DGM rack.

As shown in FIGS. 1A-1F an animal homecage 22 is enclosed by an enclosure 24 and a lid 26 placed and optionally locked in place on top of enclosure 24. Homecage 22 is here shown as rectangular with enclosure 24 including four walls 24-1, 24-2, 24-3, and 24-4 as well as floor 24-F. Homecage 22 includes means for supporting animals 50 living therein including but not limited to a nest 34, food container 28, and drink container 30 optionally including a drinking spout 32. Each homecage 22 may accommodate one or more animals 50.

In some embodiments, homecage 22 includes cage slides 36 mounted on the sides of homecage 22 for removably placing homecage 22 into a cage rack 20. As shown in FIG. 1D cage rack 20 includes multiple rack columns 40 forming the frame of cage rack 20. Rack side mounts 42 are fixedly attached between rack columns 40 for sliding cage slides 36 thereon, such as shown by arrow “A”, in order to position cages 22 into cage rack 20. Homecages 22 can be easily removed from cage rack 20, such as shown by arrow “A”, for attending to the animals or the homecages 22. Alternative means of mounting homecages 22 into cage racks are available such as shelves.

Cage rack 20 includes multiple rows and columns for accommodating multiple cages 22. In the exemplary embodiment of FIG. 1E a 6 column by 6 row cage rack 20 is shown for accommodating 36 cages 22, but this should not be considered limiting. Cage racks 20 housing up to 70 cages are not uncommon. Multiple cage racks 20 may be grouped together in different zones of a research facility. These zones may be different rooms or areas in the research facility.

It should therefore be appreciated that research institutions may be required to monitor multiple animals in multiple cages in multiple cage racks in multiple zones of the facility, totaling hundreds or thousands of animals under simultaneous observation.

One current approach to animal monitoring is manual evaluation of the animals. The animals are weighed and placed in the homecages and allowed to acclimatize to the homecage for a short period of time, typically 2-4 days. Following this period, the research is started by, for example, injecting the experimental group of animals with a pharmacological agent. The research period typically lasts for a period of days to months. During this period the animals in both control and experimental groups are repeatedly removed from their homecages and each weighed or otherwise examined to determine the effects of the applied pharmacological agents. It should be appreciated that the manual observation process is very time consuming and causes significant disturbance to the animals that are constantly removed from the homecages for observation, sometimes even at the expense of the animal recovery process. Finally, the manually measured observation points such as weight need to be entered, recorded and analyzed—an equally time-consuming process. It should also be appreciated that animal monitoring is also required by various kinds of research centers for animals that are housed and bred and are not part of any particular experiment, in order to track animal welfare and prevent any kind of discomfort or an outbreak of diseases.

Other approaches for animal observation have been proposed. Russel proposes monitoring of only a single animal per cage using an infrared photobeam with the beam source and physically separated opposite photocell receiver set in the long sides of the cage, but ultimately concludes that sniffing by the animal activates photobeam breaks more than ambulating “as might be expected” (Russell, P. A. “Sex differences in rats' stationary-cage activity measured by observation and automatic recording.” Animal Learning & Behavior 1.4 (1973): 278-282). Svensson discusses use of photobeams but concludes that more than one is required for monitoring more than a single animal as “with a single photocell one animal may block the registration of his companions' movements” (Svensson, T. H., and G. Thieme. “An investigation of a new instrument to measure motor activity of small animals.” Psychopharmacologia 14.2 (1969): 157-163).

Other monitoring products using multiple photobeams or photobeam matrixes include: a proprietary cage with 32 photobeams for measuring the movement of only a single animal sold by Omnitech Electronics; The Afasci® Smartcage is a proprietary cage that includes multiple sensors including a floor-vibration sensor, an infrared matrix and flexible modular devices for monitoring only a single animal; The PAS-Open Field from Bilaney® is a further proprietary cage that includes a 16×16 photobeam matrix for monitoring of only a single animal; U.S. Pat. No. 4,267,443 to Caroll et al discloses monitoring only a single animal using multiple photobeams which are broken in the X and Y directions in all three planes; and U.S. Pat. No. 3,304,911 to Hiroshi et al discloses use of multiple photobeams and moving cameras for monitoring of only a single animal.

Further more complex technological approaches include use of RFID tracking devices implanted into each animal that are tracked by a sensor plate added to every single cage such as the Activity Monitor of Phenosys®; The Supermex of Muromachi® includes a pyroelectric sensor for thermal analysis of only a single animal in a cage; The Digital Ventilated Cage of Tecniplast® is a proprietary cage that features a sensor base plate performing electrical capacitance sensing of movement in the cage; Genewsky discloses a proprietary cage monitored by a microwave detector (Genewsky, Andreas, et al. “A simplified microwave-based motion detector for home cage activity monitoring in mice.” Journal of biological engineering 11.1 (2017): 36); and US20100111359 to Bai et al discloses animal monitoring using at least two video cameras.

The approaches described above suffer from several limitations including:
Solutions based on proprietary cages require replacement of tens to thousands of existing cages that are already purchased and/or deployed;
Complex technologies such as cameras, multi-beam detector arrays, capacitive plates and RFID detectors are expensive to add to installations of more than a few cages, may not fit into existing cage racks, and include multiple electronic components increasing the risk of failure;
Systems designed for monitoring only a single animal do not provide a solution for homecages hosting multiple animals;
Standard maintenance procedures of the cages including washing, autoclave, sterilization etc. may be limited with specialized monitoring cages due to the potential to damage the detection mechanisms and electronics;
Changes in animal models that requires larger cages (such as hamsters and rats) require adaptation of the monitoring methodology to the new dimensions.

The problem to be solved is therefore implementation of an animal monitoring system that is scalable to large numbers, that can be retrofitted to existing homecages and cage racks, that is cost effective, that can monitor varying numbers of animals per cage, that can be deployed for different animal types and that provides long term reliability, all while still providing accurate monitoring data.

### SUMMARY

Exemplary embodiments disclosed herein relate to a system and method for monitoring animals in homecages. The homecage monitoring system (HCMS) as disclosed herein may include a detector assembly including a mounting assembly and detector configured for attachment to existing cage racks by use of an adjustable mounting assembly, a controller for interfacing with the detector, and an analyzer for collecting monitoring data from the controller. In some embodiments, environmental sensors (e.g. light, temperature, humidity) may also provide data to the controller. The detector may include a single retroreflective sensor that only needs to be mounted on one side of a monitored cage. The adjustable mounting assembly may enable positioning of the retroreflective sensor such that the retroreflective sensor can detect animal movement of multiple animals in a single homecage.

The known art disclosed above describes use in currently available systems of multiple photobeams per cage for monitoring of single animals. The industry acceptance of multiple photobeam monitoring is based on the conclusions of prior research that a single photobeam for measuring animal movement is insufficient for monitoring of a single animal in a cage and also ineffective for monitoring of multiple animals in a single cage. The use of a retroreflective-sensor-based single beam system as disclosed herein is therefore inventive based on research conducted by the inventors presented herein and as described in Vagima, Yaron, et al. “Group activity of mice in communal home cage used as an indicator of disease progression and rate of recovery: effects of LPS and influenza virus.” Life Sciences 258 (2020): 118214. The experiments below and in Vagima, et al. (2020), show a single-beam system monitoring multiple animals in a single cage providing animal movement data that correlates accurately to the animal health and thereby confirming the effectiveness of the single beam approach.

The systems and methods disclosed herein may provide multiple benefits not provided by current systems including:
The detector assembly may be easily and quickly retrofitted to existing homecages and cage racks having standard and non-standard dimension and therefore proprietary homecages are not required and existing homecages do not need to be replaced;
The compact dimensions of the detector assembly may enable installation in standard cage racks without the need to modify the cage racks or change the positioning of the homecages in the racks;
The cost-effective implementation of the detector assembly may enable deployment of large numbers of detector assemblies for simultaneous monitoring of hundreds or thousands of homecages;
The system has been demonstrated to be effective for monitoring varying numbers of animals in each homecage and is not limited to only monitoring single animals;
The system may enable effective non-intrusive monitoring of animals in homecages such that the animals do not need to be removed for examination and does not require implantation of any device or marking of the animals;
The system may be used with different animals in addition to mice (such as hamsters, guinea pigs, rats, rabbits) while using the existing homecages of varying dimensions.

The limited number of components may increase the reliability of the system such that it is suitable for large scale deployments.

In some embodiments, a homecage monitoring system includes: a detection assembly including: a single detector; a mounting assembly configured for mounting of the single detector thereto and configured for attachment of the mounting assembly adjacent to a homecage to be monitored.

In some embodiments, the system further includes a controller in data communication with the single detector and adapted for collecting the output data from the single detector. In some embodiments, the system further includes an analyzer in data communication with the controller, wherein the analyzer is a computing device. In some embodiments, the single detector includes a retroreflective sensor. In some embodiments, the system further includes sensors in communication with the controller. In some embodiments, the sensors are for one or more of: temperature, light, humidity, homecage pH, food level, water level, and animal play devices.

In some embodiments, the system further includes one or more pause buttons in communication with the controller, wherein the pause button is adapted for indicating the start and end of a period of interruption in animal monitoring to the controller. In some embodiments, the mounting assembly is configured for retrofitting to an existing cage rack. In some embodiments, the mounting assembly includes column clamps, a detector mount, and a backplane, wherein the single detector is mounted on the detector mount. In some embodiments, the detector mount is slidably attached to the backplane such that the position of the detector mount can be adjusted.

In some embodiments, the detector is mounted on the detector mount such that the detector position can be adjusted. In some embodiments, the column clamps are configured for adjusting to fit a horizontal distance between rack columns according to the cage rack dimensions. In some embodiments, multiple detection assemblies are in communication with the controller. In some embodiments, multiple controllers are in communication with the analyzer. In some embodiments, the single detector provides an output signal indicating obstruction of a light beam emitted by the detector. In some embodiments, the analyzer is adapted for collecting numbers of beam obstructions detected by the detectors. In some embodiments, the numbers of beam obstructions are displayed on a user interface of the analyzer.

In some embodiments, a method for monitoring animals in a homecage comprises: providing the homecage monitoring system positioned opposite a homecage including the animals for monitoring; and monitoring the detected beam breaks of the single detector to determine animal activity. In some embodiments, pressing of the pause button results in a pause in monitoring or an indication of the time period of an interruption. In some embodiments, data from the sensors is used for analysis of animal activity as detected.

According to at least some embodiments, a homecage monitoring system includes: a detection assembly including: a single detector; a mounting assembly configured for mounting of the single detector thereto and for attachment of the mounting assembly to a cage rack adjacent to a homecage to be monitored; and a controller in data communication with the single detector and adapted for collecting the output data from the single detector. In some embodiments, the system further includes an analyzer in data communication with the controller, wherein the analyzer is a computing device.

In some embodiments, the single detector includes a retroreflective sensor. In some embodiments, the system further includes sensors in communication with the controller. In some embodiments, the sensors are selected from the group consisting of: sensors for temperature, light, humidity, homecage pH, food level, water level, and animal play devices. In some embodiments, the system further includes one or more pause buttons in communication with the controller, wherein the pause button is adapted for indicating the start and end of a period of interruption in animal monitoring.

In some embodiments, the mounting assembly is adapted for retrofitting to an existing standard and/or non-standard cage rack. In some embodiments, the mounting assembly includes a detector mount and a backplane, wherein the single detector is mounted on the detector mount. In some embodiments, the detector mount is slidably attached to the backplane such that the position of the detector mount can be adjusted. In some embodiments, the detector is mounted on the detector mount such that the detector position can be adjusted. In some embodiments, multiple detection assemblies are in communication with the controller. In some embodiments, multiple controllers are in communication with the analyzer.

In some embodiments, the single detector provides an output signal indicating breaking of a light beam emitted by the detector. In some embodiments, the analyzer is adapted for collecting numbers of beam breaks detected by the detectors. In some embodiments, the numbers of beam breaks are displayed on a user interface of the analyzer.

In some embodiments, a method for monitoring animals in a homecage includes: providing the system as described above attached to a homecage including the animals for monitoring; and monitoring the detected beam breaks of the single detector to determine animal activity. In some embodiments, pressing of the pause button results in a pause in monitoring. In some embodiments, data from the sensors is used for analysis of animal activity as detected.

The term “animal” as used herein may refer to any type of animal typically used in laboratory experimentation including but not limited to mice, rats, guinea pigs, hamsters, rabbits, fish, primates, amphibians, reptiles and so forth. The term “homecage” as used herein refers to any laboratory enclosure for housing animals and includes cages, terrariums, and aquariums.

As used herein the term “existing” as it relates to homecages and/or cage racks refers to homecages and/or cage racks that do not have automated processor-based monitoring built into the homecage or cage rack and therefore require some form of retrofitting of a monitoring system (such as disclosed herein) in order to provide automated processor-based monitoring of animals in the homecage or cage rack. Advantageously, the HCMS as disclosed herein may be retrofitted to existing cage racks for providing automated processor-based monitoring of animals in the homecages therein. Existing homecages and/or cage racks may have already been acquired and/or are in use by an institution or refer to homecages and/or cage racks of a type routinely acquired by an institution. Existing homecages and/or cage racks may be of varying dimensions.

As used herein the term “standard” as it relates to homecages and/or cage racks may refer to homecages and/or cage racks manufactured in large quantities (thousands per year) by recognized homecage manufacturers known in the art with no modification made to the homecages and/or cage racks for automated processor-based monitoring purposes. A non-limiting example of a standard homecage used for small rodents is the Tecniplast® 1500U having dimensions of 513×381×256 mm (L×W×H) and a non-limiting example of a standard cage rack is the associated 2U20 rack having a capacity of 20 1500U cages. Existing cages may be standard or non-standard.

Although the experiments included herein relate to mice and hamsters, it should be appreciated that the system disclosed herein may be adapted for monitoring of any type of animal.

Various embodiments are described herein with reference to a system, method, device, or computer readable medium. It is intended that the disclosure of one is a disclosure for all. For example, it is to be understood that disclosure of a computer readable medium described herein also constitutes a disclosure of methods implemented by the computer readable medium, and systems and devices for implementing those methods, via for example. at least one processor. It is to be understood that this form of disclosure is for each of discussion only, and one or more aspects of one-embodiment herein may be combined with one or more aspects of other embodiments herein, within the intended scope of this disclosure.

The details of one or more implementations are set forth in the accompanying drawings and the description below. Other features will be apparent from the description and drawings.

### BRIEF DESCRIPTION OF THE DRAWINGS

Aspects, embodiments, and features disclosed herein will become apparent from the following detailed description when considered in conjunction with the accompanying drawings. Like elements may be marked with like numerals in different figures, where:

FIGS. 1A-1E show illustrations of homecages and cage racks;

FIG. 1F shows a photograph of animals in a homecage;

FIGS. 2A-2C show exemplary block diagrams of a system for monitoring animals in homecages consistent with some embodiments of this disclosure;

FIGS. 2D-2K show exemplary illustrations of a system for monitoring animals in homecages consistent with some embodiments of this disclosure;

FIG. 2L shows an exemplary screenshot of monitored data consistent with some embodiments of this disclosure;

FIG. 3 shows a flowchart of a method for monitoring animals in homecages consistent with some embodiments of this disclosure;

FIGS. 4, 5A, 5B, 6, and 7 show graphs of experimental data gathered using the homecage monitoring system consistent with some embodiments of this disclosure.

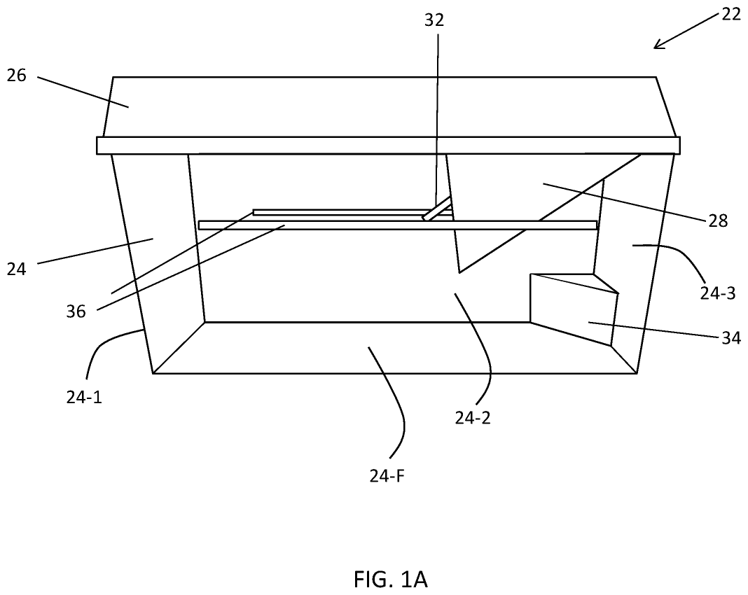

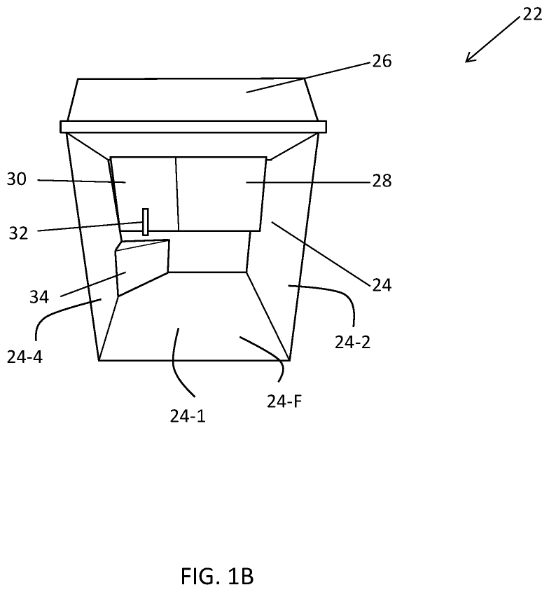

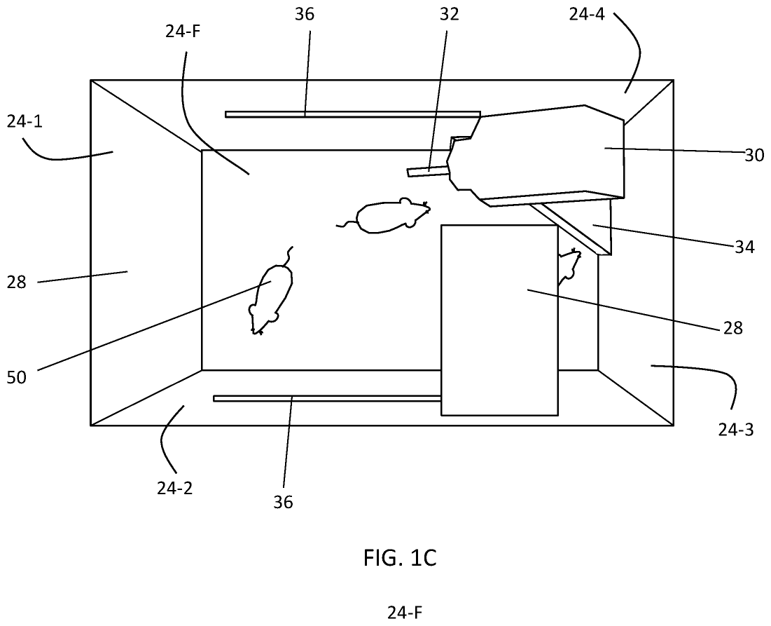

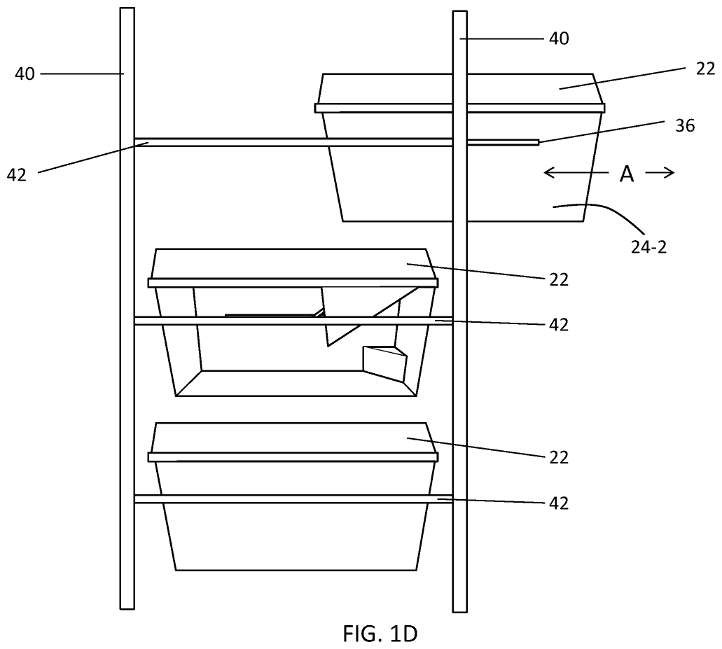

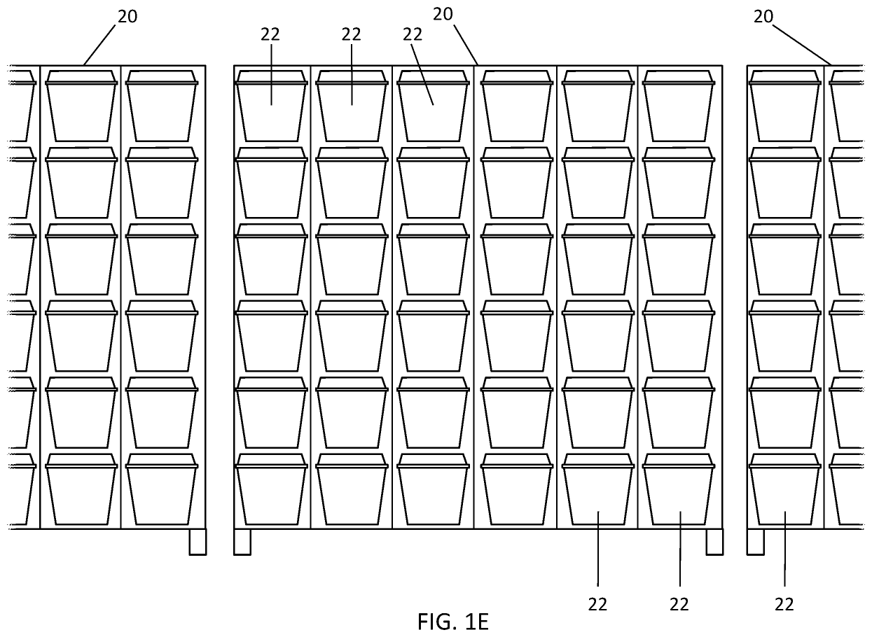

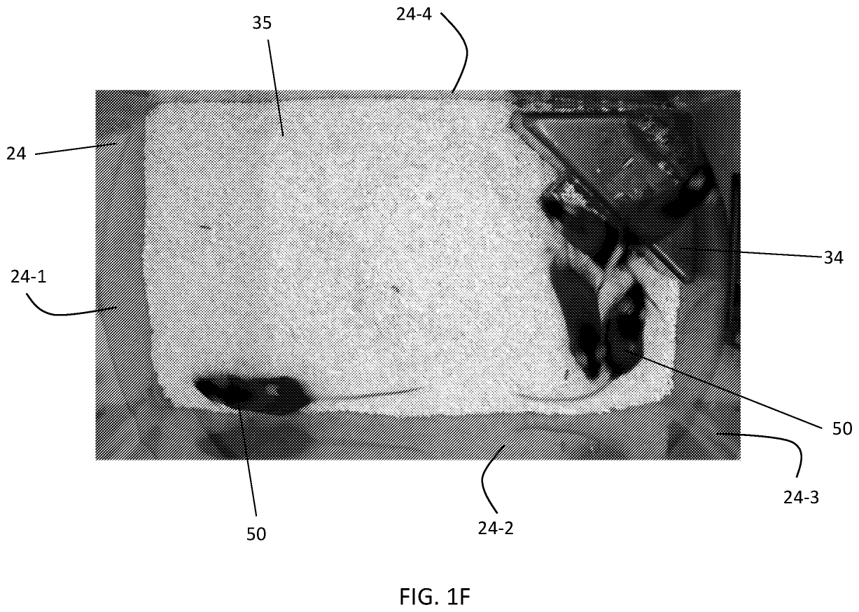

### DETAILED DESCRIPTION

The present disclosure describes technological improvements in devices, systems, methods, and computer readable media for animal monitoring platforms that may allow monitoring of large numbers of animals in homecages.

Reference will now be made in detail to non-limiting examples of this disclosure, examples of which are illustrated in the accompanying drawings. The examples are described below by referring to the drawings, wherein like reference numerals refer to like elements. When similar reference numerals are shown, corresponding description(s) are not repeated, and the interested reader is referred to the previously discussed figure(s) for a description of the like element(s).

Aspects of this disclosure may provide a technical solution to the challenging technical problem of animal monitoring and may relate to a system for platforms that may allow monitoring of large numbers of animals in homecages with the system having at least one processor (e.g., processor, processing circuit or other processing structure described herein), including methods, systems, devices, and computer-readable media. For ease of discussion, example methods are described below with the understanding that aspects of the example methods apply equally to systems, devices, and computer-readable media. For example, some aspects of such methods may be implemented by a computing device or software running thereon. The computing device may include at least one processor (e.g., a CPU, GPU, DSP, FPGA, ASIC, or any circuitry for performing logical operations on input data) to perform the example methods. Other aspects of such methods may be implemented over a network (e.g., a wired network, a wireless network, or both).

As another example, some aspects of such methods may be implemented as operations or program codes in a non-transitory computer-readable medium. The operations or program codes may be executed by at least one processor. Non-transitory computer readable media, as described herein, may be implemented as any combination of hardware, firmware, software, or any medium capable of storing data that is readable by any computing device with a processor for performing methods or operations represented by the stored data. In a broadest sense, the example methods are not limited to particular physical or electronic instrumentalities, but rather may be accomplished using many differing instrumentalities.

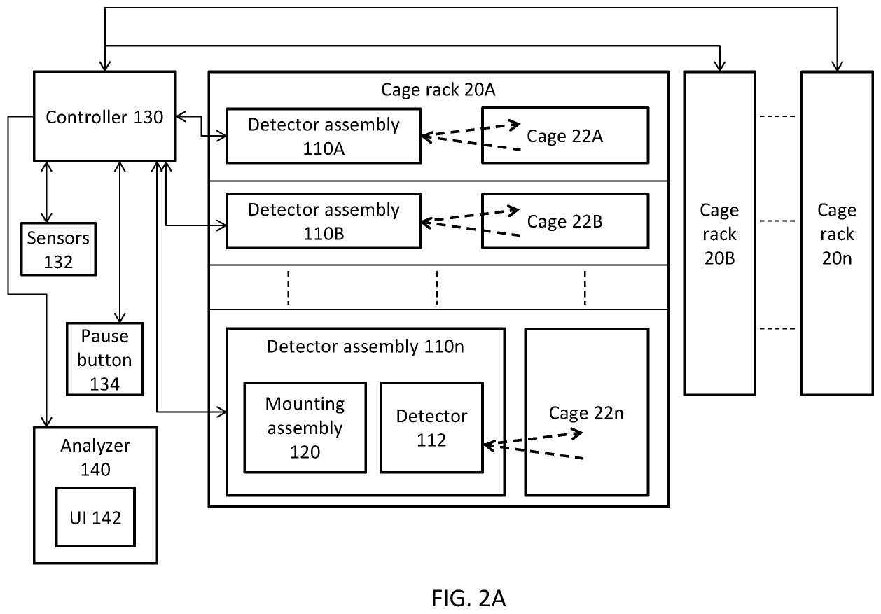

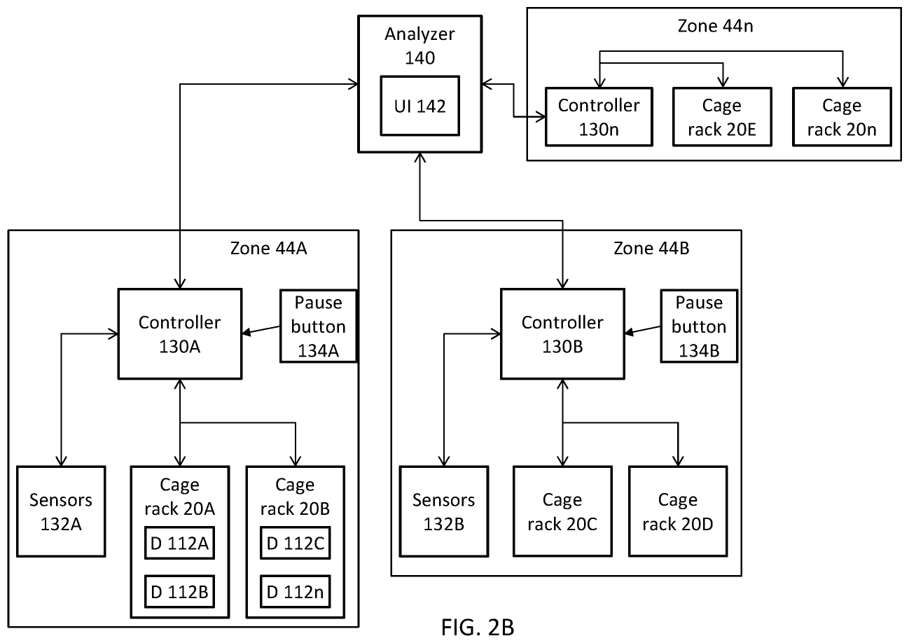

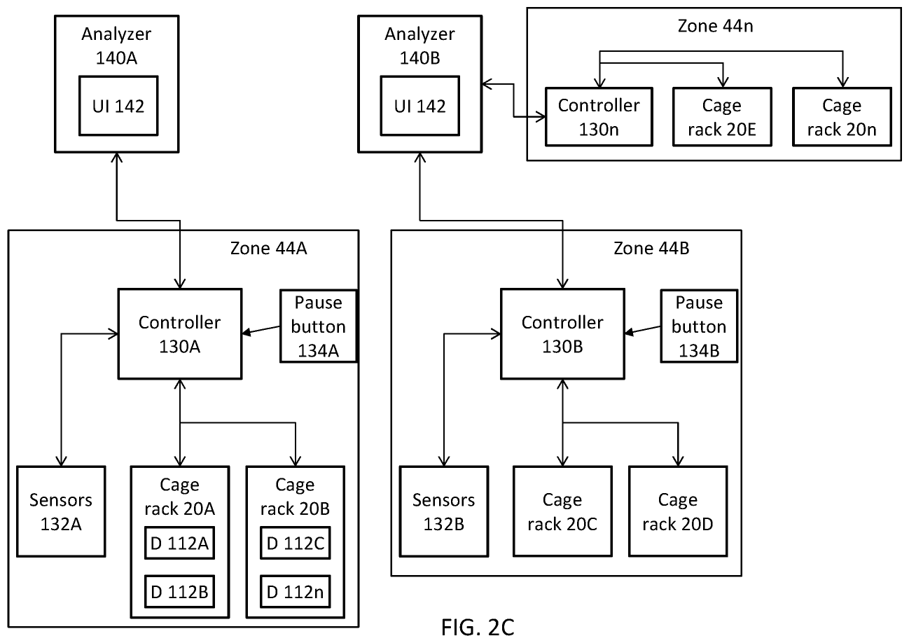

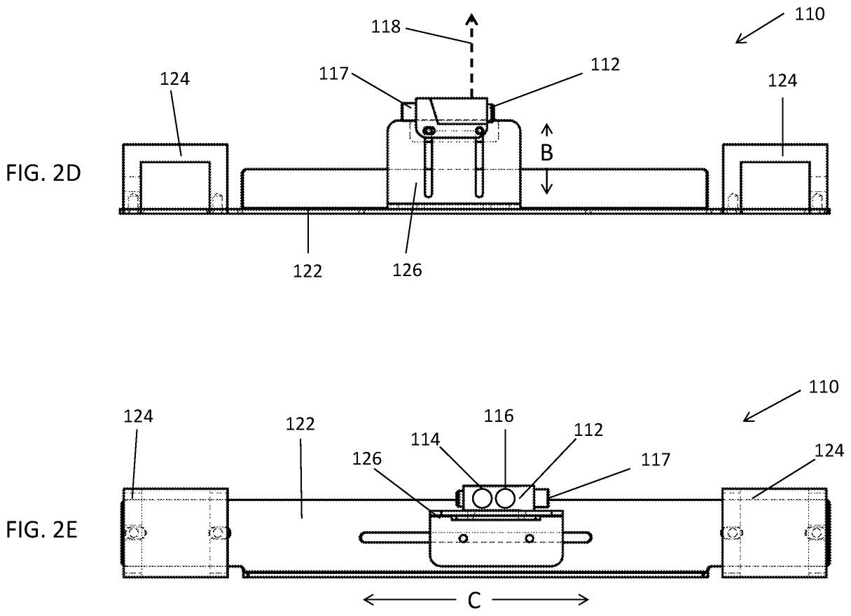

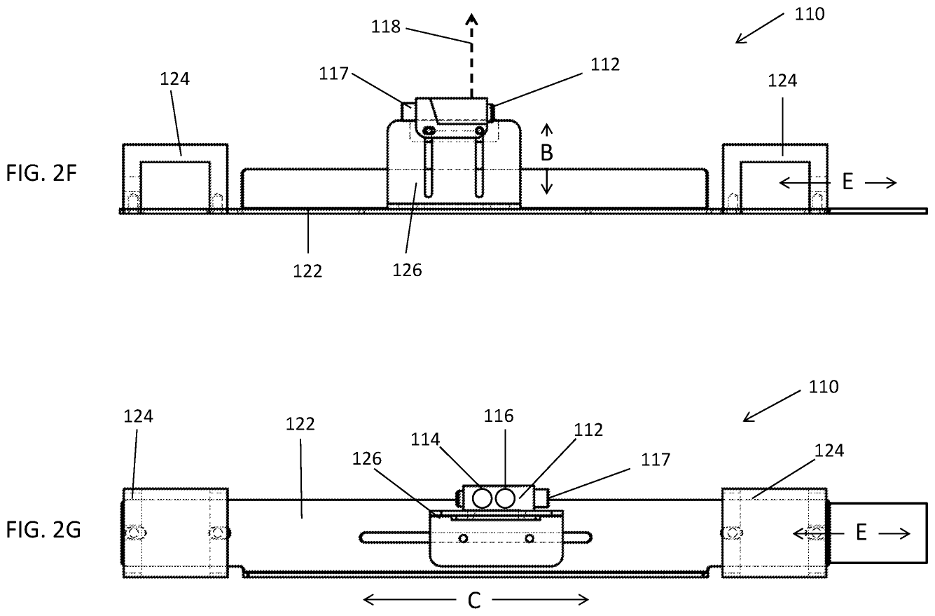

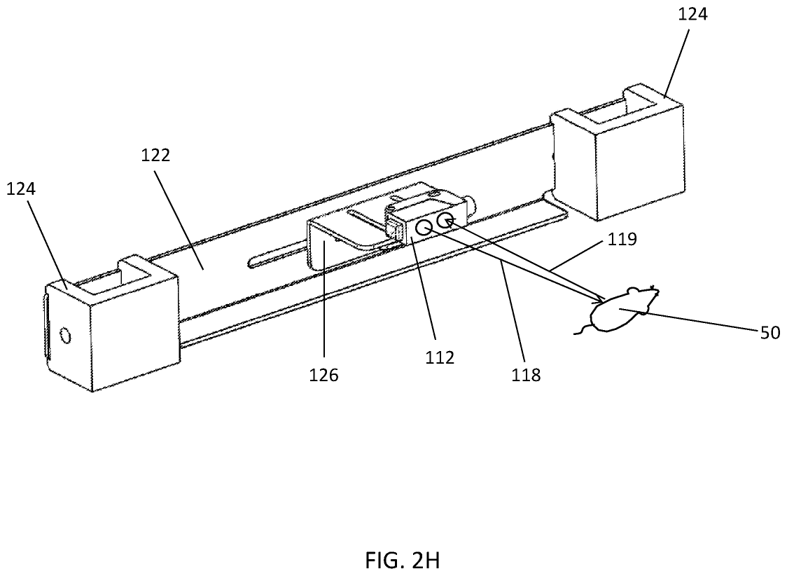

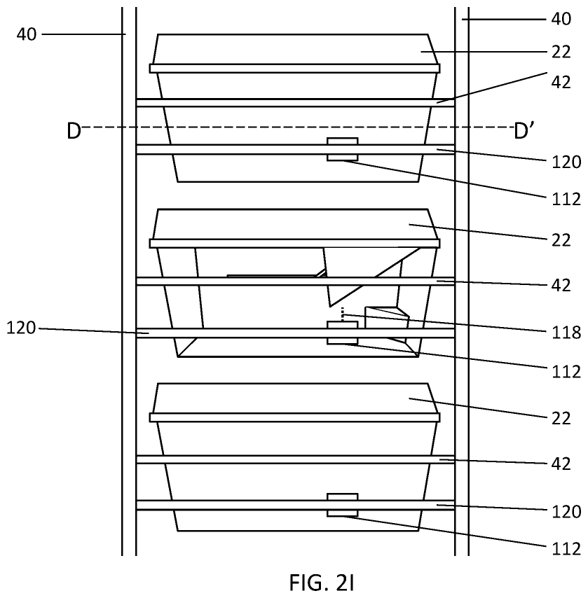

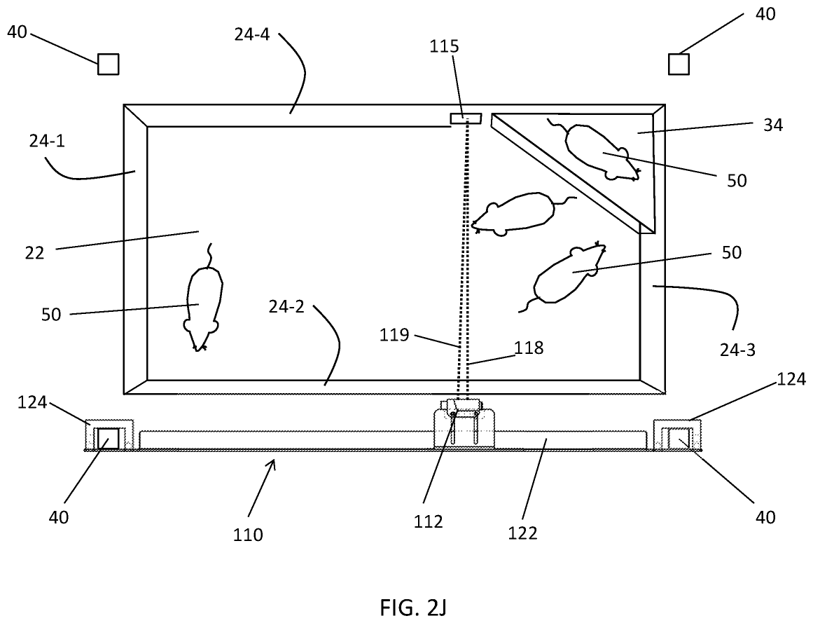

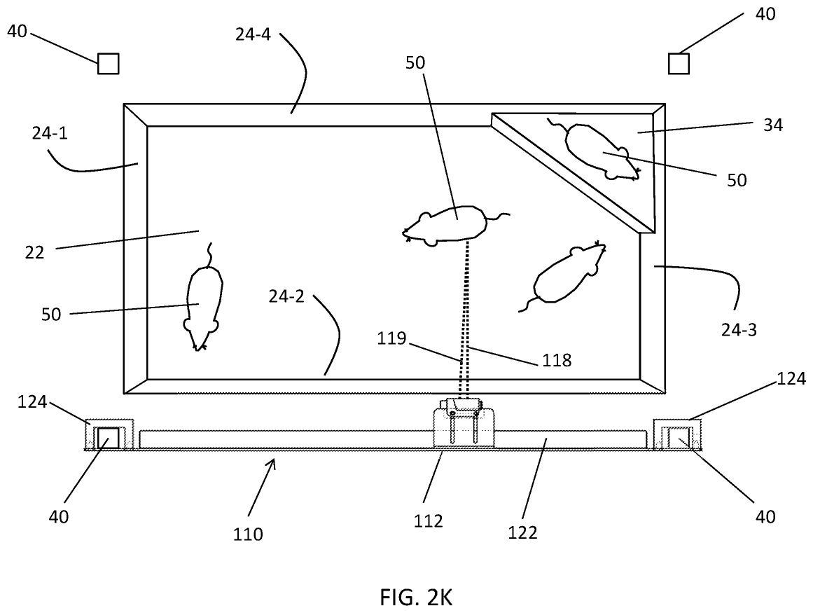

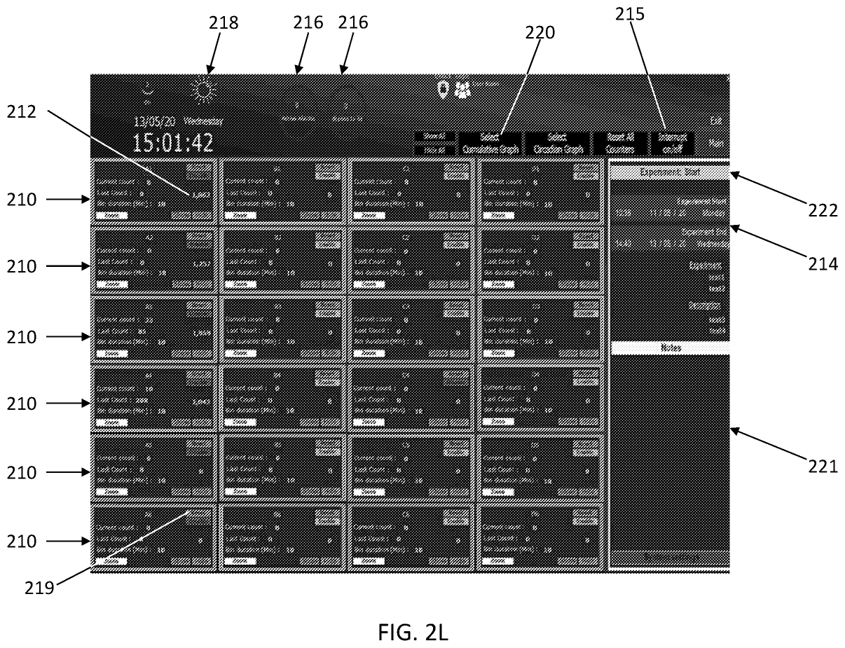

Referring to the figures, FIGS. 2A-2C show exemplary block diagrams of a system for monitoring animals in homecages consistent with embodiments of this disclosure, FIGS. 2D-2K show exemplary illustrations of a system for monitoring animals in homecages consistent with embodiments of this disclosure, and FIG. 2L shows an exemplary screenshot of monitored data consistent with embodiments of this disclosure. As shown in FIG. 2A a homecage monitoring system (HCMS) 100 may include a detector assembly 110, a controller 130, and an analyzer 140. In some embodiments, HCMS 100 may also include environmental sensors 132.

One detector assembly 110 may be mounted adjacent to each homecage 22 that is to be monitored. In FIG. 2A, within cage rack 20A, three detector assemblies 110A, 110B, and 110n are shown, each associated with a homecage 22A, 22B, and 22n. Further, cage racks 20B, and 20n may also include homecages 22 monitored by detector assemblies 110. It should therefore be appreciated that large numbers of homecages 22 in multiple cage racks 20 may each be monitored by a separate detector assembly 110 mounted adjacent thereto, and the numbers of homecages 22, cage racks 20 and detection assemblies 110 shown in the figures should not be considered limiting.

As shown in FIGS. 2D-2H detector assembly 110 may include a detector 112 and a mounting assembly 120. In some embodiments, detector 112 may include a retroreflective sensor also referred to as a diffuse photo sensor. Detector 112 may include an emitter 114 and a receiver 116 in a single housing. In some embodiments, emitter 114 may be a laser emitter. It should be appreciated that housing of emitter 114 and receiver 116 in a single housing eases installation of detector assembly 110, since the installation is on a single side of the cage 22 to be monitored, i.e.: no provision needs to be made for separated emitters and receivers. Detector 112 may include a detector output 117 for wired or wireless data communication with controller 130. In some embodiments, reflective or opaque material 115 (FIG. 2J) may be placed on the wall 24 opposite emitter 114. In use, detector assemblies 110 may be mounted consistently on the same side of the cages 22 in cage rack 20. Alternatively, detector assemblies 110 may be mounted back to back on alternate columns of the cages 22 in cage rack 20.

Detector 112 is configured for being fixedly positioned adjacent to a homecage 22 to be monitored. In some embodiments, detector 112 is adapted for retrofitting to an existing homecage or cage rack. In some embodiments, mounting assembly 120 is configured for mounting of the single detector 112 thereto. Mounting assembly 120 is configured for attachment of the mounting assembly 120 to a cage rack 20 adjacent to a homecage 22 to be monitored. In some embodiments, detector assembly 110 is adapted for retrofitting to an existing cage rack by including an adaptable mounting assembly 120. Mounting assembly 120 includes backplane 122, column clamps 124, and detector mount 126. Backplane 122 extends between and is fixedly attached to column clamps 124. Column clamps 124 are spaced one from another in a horizontal plane so as to substantially match the horizontal distance between the rack columns 40 of a cage rack 20 in which mounting assembly 120 is to be mounted. In some embodiments, such as shown in FIGS. 2F and 2G one or both of column clamps 124 may be adjustable in a horizontal plane to enable movement of one or both of column clamps 124 in a direction “E” for attachment of backplane 122 to cage racks 20 with rack columns 40 spaced at varying distances from one another. In FIGS. 2F and 2G only one column clamp 124 is shown as adjustable for simplicity, but in practice both column clamps 124 may be adjustable.

Detector mount 126 is slidably attached to backplane 122 such that the position of detector mount 126 can be adjusted in a direction shown by arrow “C”. Detector 112 is slidably mounted on detector mount 126 such that the position of detector 112 can be adjusted in a direction shown by arrow “B”. As shown in FIG. 21 mounting assemblies 120 are positioned on the sides of cage racks 20 adjacent to homecages 22. The height of detector assembly 110 and horizontal position of detector 112 relative to homecage 22 to be monitored can be simply adjusted by moving column clamps 124 up or down and/or detector mount 126 in direction C and/or detector 112 in direction B. As shown in FIGS. 2J and 2K, column clamps 124 are placed and tightened onto rack columns 40 to hold detector assembly 110 in place on cage rack 20. Although detector assembly 110 is here shown proximal to side 24-2, it should be appreciated that detector assembly 110 may be mounted proximal to any of the sides of enclosure 24 where a convenient attachment point for detector assembly 110 is available.

Alternative means of configuring detector assembly 110 for mounting to an existing cage rack 20 or homecage 22 may be contemplated including mounting of detector 112 directly to homecage 22 or to another part of cage rack 20 such as to a single rack column 40 or to a rack side mount 42 with an appropriate mounting assembly.

In use, the emitted light beam 118 produced by emitter 114 is reflected back to receiver 116 as reflected light 119 by a reflector. When emitted light beam 118 is obstructed by a reflector the amount of reflected light 119 that arrives at receiver 116 may change. Where no animal obstructs beam 118, the beam 118 is reflected as steady state beam 119 off the opposite wall of homecage 22. When a change in reflected light 119 is detected, the output signal of detector 112 may change state indicating an obstruction of beam 118. As shown in FIGS. 2J and 2K, when not obstructed by an animal 50, emitted light beam 118 is reflected off the opposite wall of cage enclosure 24 (or optionally off reflective or opaque material 115). When an animal 50 obstructs emitted light beam 118, the obstructed reflected light 119 may be different to that of steady state reflected light 119 from the opposite wall of cage enclosure 24 and detector 112 may indicate an obstruction via detector output 117 to controller 130.

Each detector 112 may be in wired or wireless data communication with controller 130. Wireless communication between detector 112 and controller 130 may utilize any suitable wireless protocol or standard such as but not limited to WiFi, Bluetooth, Zigbee, and so forth. Controller 130 is a computing device as defined herein and includes at least one processor. In some embodiments, controller 130 may include hardware interface cards (not shown) for monitoring detectors 112. Each beam obstruction transmitted by each detector 112 to controller 130 may be counted by controller 130. In some embodiments, a constant signal from detector 112 indicating a constant obstruction of emitted light beam 118 that exceeds a defined period of time may be identified by controller 130 as an alarm condition. Such a condition might be caused for example by an immobile animal 50 or by movement of nesting material 35 that obstructs emitted light beam 118.

Controller 130 may be in wired or wireless data communication with an analyzer 140. Analyzer 140 is a computing device as defined herein including at least one processor. In some embodiments, analyzer 140 is a distributed server or cloud computing environment. Analyzer 140 may include a user interface (UI) 142. In some embodiments, multiple UIs 142 may be supported to enable access to analyzer 140 by multiple users simultaneously. UI 142 may include means for human interaction with analyzer 140 including input means such as a keyboard, mouse and/or touch screen and output means such a screen, audio output or visual indicators.

Analyzer 140 may periodically or continuously receive cumulative or single detector 112 obstruction counts for each deployed detector 112 from controller 130. Analyzer 140 may summarize data received from controller 130 for display on UI 142, or for saving and/or transfer to other analytical systems (not shown).

FIG. 2L shows an exemplary screenshot from UI 142 of analyzer 140 showing summaries 210 for each homecage 22 monitored by a detector 112. Summaries 210 may each include an accumulated obstruction count 212 per analysis period 214. This data may further be automatically displayed graphically on UI 142 as described further below with reference to the experimental data. In some embodiments, controller 130 may also forward alarm and status conditions 216 and these may be indicated on UI 142, such as blocked detector, blocked detector for more than defined period of time, detector status, lighting on or off in zone 218, non-responsive detector, pause button activation and so forth. Additionally, in some embodiments, alarm conditions may be indicated by audio alarms generated in analyzer 140. In some embodiments, light on/off data may be gathered by analyzer 140 for tracking of circadian rhythms of monitored animals.

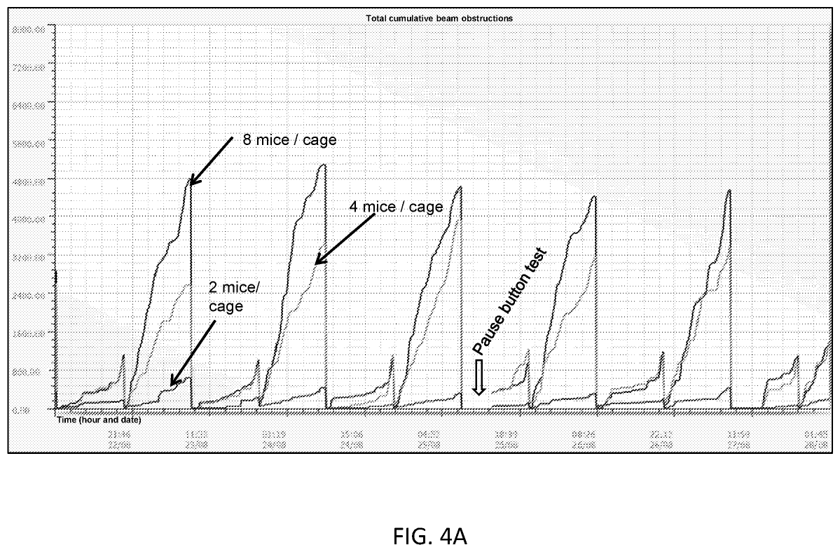

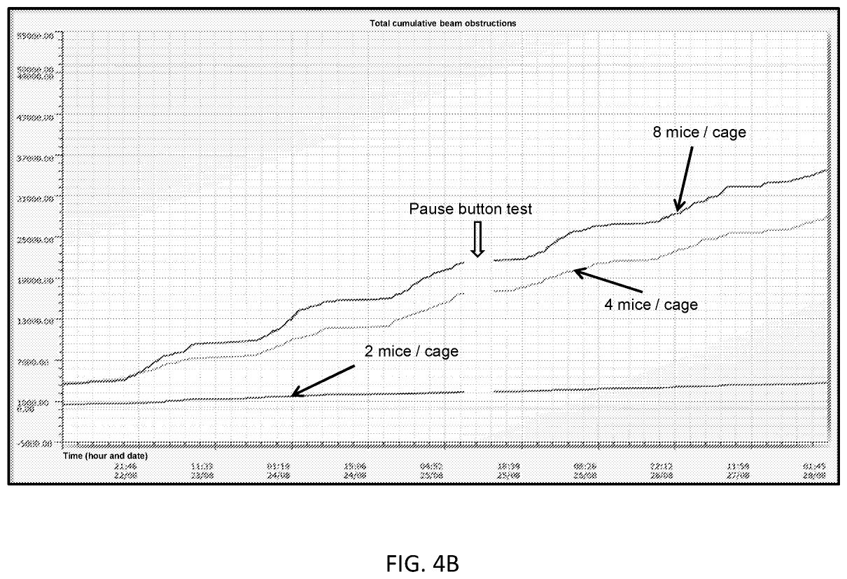

In some embodiments, UI 142 may also provide action buttons such as but not limited to: reset button 219 for zeroing the activity (obstruction) count such as when a new monitoring period is started, an interrupt button 215 such as describe above, and “show graph” button 220 for displaying a graph of gathered data such as the experimental data described below (FIGS. 4-7). In some embodiments, graphs showing activity for different numbers of animals may be normalized for easier comparison. In some embodiments, graphs include a defined tolerance zone such that exceeding the tolerance zone will generate an alarm.

In some embodiments, such as shown in FIG. 2B, more than one controller 130 may be deployed. A non-limiting example of such a multi-controller environment occurs when one or more cage racks 20 and corresponding detection assemblies 110 are deployed in different zones 44. A zone as defined herein may include a divided room, complete room, area, building and so forth. As shown in FIG. 2B, each of controllers 130A, 130B, and 130n respectively located in zones 44A, 44B, and 44n are in data communication with analyzer 140. Each of controllers 130A, 130B, and 130n may be in wired or wireless data communication with the detectors 112 in cage racks 20A-20B, 20C-20D, and 20E-20n (such as detectors 112A-112n in cage racks 20A-20B). Alternatively, in some embodiments, such as shown in FIG. 2C, groups or individual controllers 130 may each be in separate communication with more than one analyzer 140A or 140B.

It should therefore be appreciated that large numbers of homecages 22 in multiple cage racks 20 situated in multiple zones 44 may each be monitored by a separate detector assembly 110 mounted adjacent to each monitored homecage 22 and controlled by controller 130 reporting to an analyzer 140, and the numbers of zones 44, homecages 22, cage racks 20 and detection assemblies 110 shown in the figures should not be considered limiting. HCMS 100 may therefore support simultaneous monitoring of hundreds to thousands of homecages 22 each holding multiple animals 50. Further, as shown, HCMS 100 may include a minimal number of components that may be easily retrofitted to existing cages enabling fast deployment of HCMS 100 to large installed bases of cages.

In some embodiments, environmental sensors 132 may be in wired or wireless data communication with controller 130. As shown in FIGS. 2B and 2C, sensors 132 may be installed per zone, such as sensors 132A in zone 44a and sensors 132B in zone 44B. In some embodiments, where sensors 132 are installed in a specific zone 44, HCMS 100 may associate the sensors 132 with the zone 44 in which they are installed for purposes of data collection and analysis. Non-limiting examples of sensors 132 include sensors for: temperature, light, humidity, homecage pH, food level, water level, animal play devices and so forth. Data from sensors 132 may be collected by controller 130 or transmitted to controller 130 by sensors 132 and provided by controller 130 to Analyzer 140 for inclusion in collected data and for analysis. A non-limiting example of sensor 132 usage is monitoring light by use of a light sensor in a room (zone) 44 containing multiple monitored homecages 22 for correlating animal behavior with light conditions (circadian rhythms), where controller 130 collects the light status such as light on or light off.

In some embodiments, a pause button 134 is provided. As shown in FIGS. 2B and 2C, pause button 134 may be installed per zone, such as pause buttons 134A in zone 44a and pause button 134B in zone 44B. In some embodiments, where pause buttons 134 are installed in a specific zone 44, HCMS 100 may associate the pause buttons 134 with the zone 44 in which they are installed for purposes of data collection and analysis. Pause button 134 includes a push button or touch screen or other interface for indicating the start of a period of interruption in animal monitoring or an indication for continued monitoring during a period where the cage and/or animals are disturbed. In some embodiments, pressing (activation) of the pause button pauses the collection of count data from detectors 112 and deactivation causes resumption of collection of count data. In some embodiments, pressing (activation) of the pause button indicates to controller 130 that a disturbance period has started and deactivation indicates that the disturbance period has ended such that the disturbance period can be recorded by controller 130 and/or analyzer 140 for use in manual or automated analysis of results. Activation of pause button 134 may be required, for example, when a researcher enters a room (zone) 44 to handle homecages 22, or adjust detectors 112, or switch on the light during the night, or any other activity that may cause disruption to the results being collected. In some embodiments, pause button 134 may be provided in software as part of UI 142 in analyzer. In some embodiments, pause button 134 may be activated for a specific detector 112 or specific zone only. Pause button 134 may be deactivated when the potential disturbance has ended, and monitoring may return to normal. Alternatively, as stated above, activation and deactivation of pause button 134 does not stop collection of data from detectors 112 but rather may record the disturbance period for inclusion in result analysis.

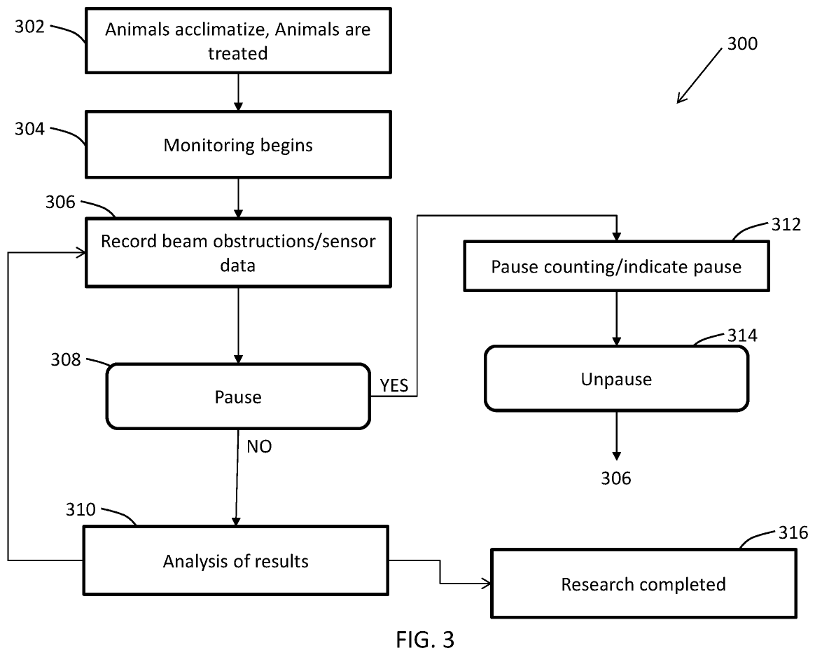

Reference is made to FIG. 3 showing a flowchart of a method for monitoring animals in homecages consistent with embodiments of this disclosure. Process 300 may be performed using HCMS 100 as described above. As part of process 300 HCMS 100 may be set up and operated by one or more users such as but not limited to researchers or scientists. Before starting the process 300 shown in in FIG. 3, an initial setup of HCMS 100 needs to be performed including installation of detection assemblies 110 on cage racks 20, connection of detectors 112 to controller 130, definition in controller 130 and/or analyzer 140 of the association between the physical homecage and its adjacent detector 112, connection of sensors 132 and pause button 134 to controller 130, connection of controller 130 to analyzer 140, and definition of zones 44 and the relationship between detectors/sensors/pause buttons and zones.

In step 302, groups of animals (control and experimental) are placed in the homecages and may be allowed to acclimatize to the homecages for a short period of time, typically 2-4 days to monitor (using beam obstruction counts) and record data (including beam obstruction counts) about spontaneous movement of healthy animals and to calibrate the baseline of day/night activity. Following this period, the research is started by, for example, injecting the experimental group of animals with a pharmacological agent. All experimental procedures at the beginning and during the experiment may be documented in the “Note” tab 221 (FIG. 2L).

In step 304, which may begin before, during or after step 302, monitoring of the animals begins such as by initiating the collection of beam obstruction counts from detectors 112 and also sensor data from sensors 132 by controller 130. In step 306 recording of beam obstruction counts from detectors 112 and also sensor data from sensors 132 by controller 130 may be initiated such as by selecting an “Experiment start” button 222 (FIG. 2L) to initiate data recording associated with the experiment timeframe on analyzer 140. In some implementations, monitoring/recording may be initiated during the acclimatization period or at some point prior to starting the research period. The monitoring/recording may be initiated by a user interacting with a UI 142 of analyzer 140. HCMS 100 may also be deployed and monitoring/recording initiated for continual monitoring of animal welfare of animals that are not part of active experiments/research, such as for but not limited to animals that may be housed by the research institution for future research projects. These animals also require monitoring to detect changes in behavior that may indicate diseases or problems with housing of the animals. Use of HCMS for welfare monitoring is thus long term and has no set termination time. Steps 304 and 306 may therefore occur together when monitoring and recording of data occur together.

In some embodiments, the animals are not disturbed (physically) during a recorded monitoring period. In some embodiments, animals may be physically disturbed such as where this is deemed to have a negligible effect on monitoring results. During the monitoring period at any time, in step 310, analysis of the results is performed by one or more users (researchers/assistants). In an optional step 308, monitoring/recording is paused by activating pause button 134 by a user such as when cages are cleaned, or animals are physically disturbed, or for removal of dead animals. When the pause button is deactivated in step 314, counting and data recording by the controller and analyzer continues as in step 306. Alternatively, activation/deactivation of the pause button may be recorded in analyzer 140 along with data from the interruption period i.e.: without stopping recording. In step 316, the research is deemed to be completed (as determined by the researchers/users) and a final analysis of the monitoring results may be performed by the users. Continual monitoring does not proceed to step 316 but rather involves repetition of steps 306, 308, and 310 on a continual basis.

### Experimental Data

The following experiments were performed using HCMS 100 disclosed above to verify that the monitored animal movement data of multiple animals detected using a single beam correlates accurately to the animal health to thereby confirm the effectiveness of the single beam monitoring approach provided by HCMS 100 for multiple cages simultaneously and multiple animals per cage. The experimental data shown below proves the efficacy of the HCMS 100 by showing first the activity differences associate with circadian rhythm and in measured activity between the control and experimental groups as measured by counts of beam obstructions of the single beam.

### Experiment 1

Drawing reference: FIGS. 4A and 4B showing exemplary screenshots of graph outputs of UI 145.
Title: Circadian activity and continuous activity monitoring and graphing.
Method: Simultaneously monitor various numbers of mice per cage using the HCMS 100.
Number of cages monitored: 3
Animal type: Mice
Cage 1, Animal Group 1: 8 animals.
Cage 2, Animal Group 2: 4 animals.
Cage 3, Animal Group 3: 2 animals.

Description: The graphs as shown in FIG. 4A are cumulative beam obstructions by all animals combined in each cage synchronized with the circadian rhythms of the animals under test based on light sensors in the zone being tested. Therefore, the cumulative count is reset for dark (Night) and light (Day) periods every 12 hours (e.g. 6:00 am/18:00 pm). As shown, the differences in cumulative activity in each cage can immediately be seen according to the number of animals per cage. Animal activity is significantly reduced during daytime as expected from nocturnal animals. The graphs as shown in FIG. 4B are total-cumulative beam obstructions without count resets every 12 hours. A pause button test is also illustrated.

### Experiment 2

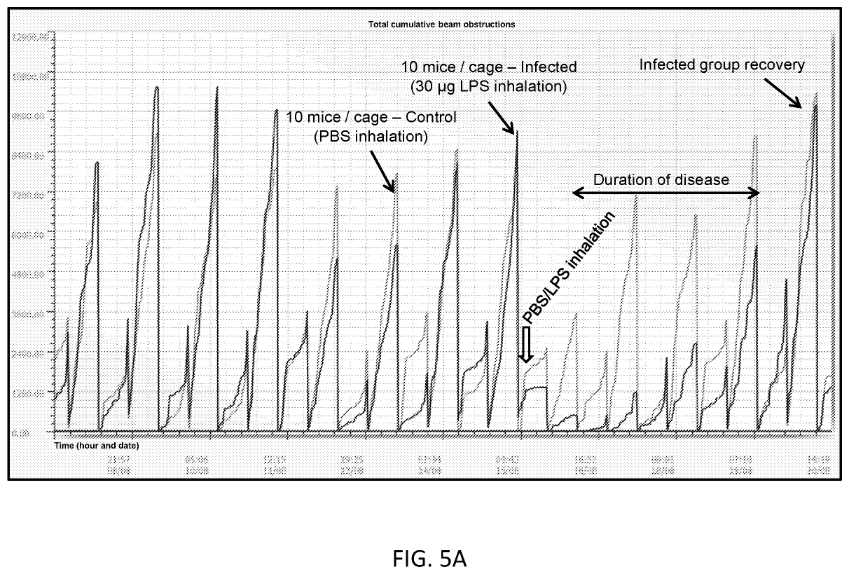

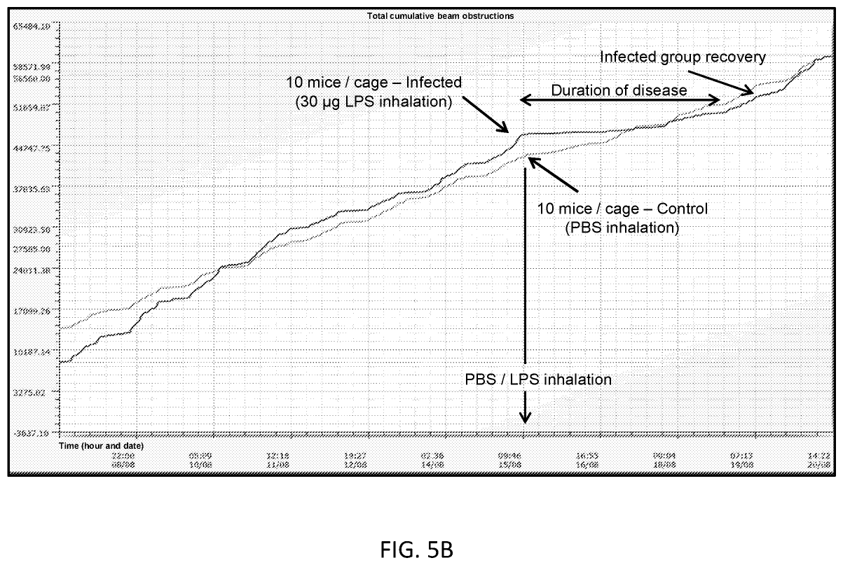

Drawing reference: FIGS. 5A and 5B showing exemplary screenshots of graph outputs of UI 145
Title: Comparative pharmacological exposure
Method: 10 mice per cage were exposed intranasally to either PBS (control) or LPS and morbidity aspects were simultaneously monitored using HCMS 100.
Number of cages monitored: 2
Animal type: Mice
Cage 1, Animal Group 1: Control group of 10 animals
Cage 2, Animal Group 2: 10 Animals each infected intranasally with 30 μg of LPS

Description: The graphs as shown in FIG. 5A and the graphs as shown in FIG. 5B are cumulative beam obstructions by all animals combined in each cage. As shown in FIG. 5A, the animals in homecage 2 were exposed to 30 μg of LPS each. The cumulative activity can immediately be seen to decrease and remain below that of the mice in the control group of homecage 1. After approximately 3.5 days the mice in homecage 2 recover from the infection and their activity returns to normal. As shown in FIGS. 5A and 5B, after recovery, the activity graphs track each other.

### Experiment 3

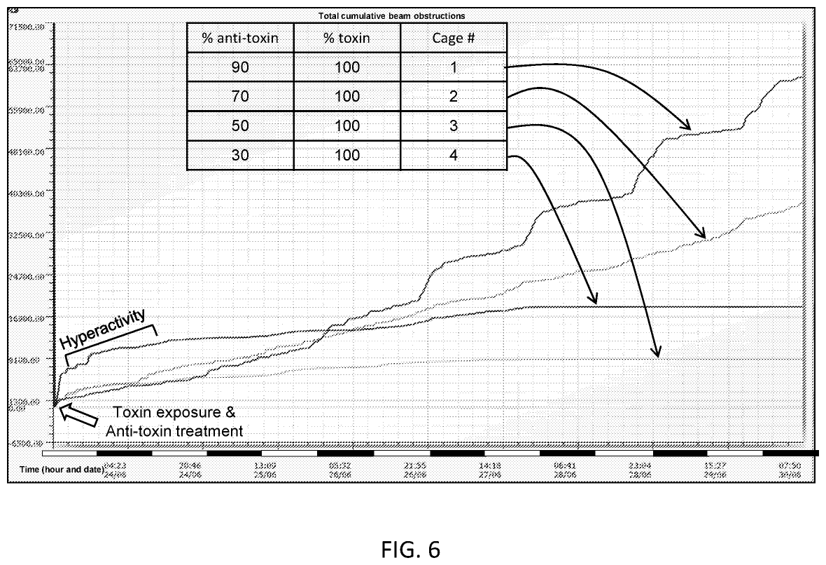

Drawing reference: FIG. 6
Number of cages monitored: 4
Animal type: Mice
Cage 1, Animal Group 1: 5 Animals each injected with toxin and 90% anti-toxin
Cage 2, Animal Group 2: 5 Animals each injected with toxin and 70% anti-toxin
Cage 3, Animal Group 3: 5 Animals each injected with toxin and 50% anti-toxin
Cage 4, Animal Group 4: 5 Animals each injected with toxin and 30% anti-toxin

Description: The graphs as shown in FIG. 6 are cumulative beam obstructions by all animals combined in each cage. As shown, the cumulative activity of Group 1 can immediately be seen to be higher than that of Group 2. Groups 3 and 4 show leveling off indicating morbidity and mortality of the animals in the groups. A period of hyperactivity at the start of the monitoring period is also evidence of induced intoxication for the animals of cage 4.

### Experiment 4

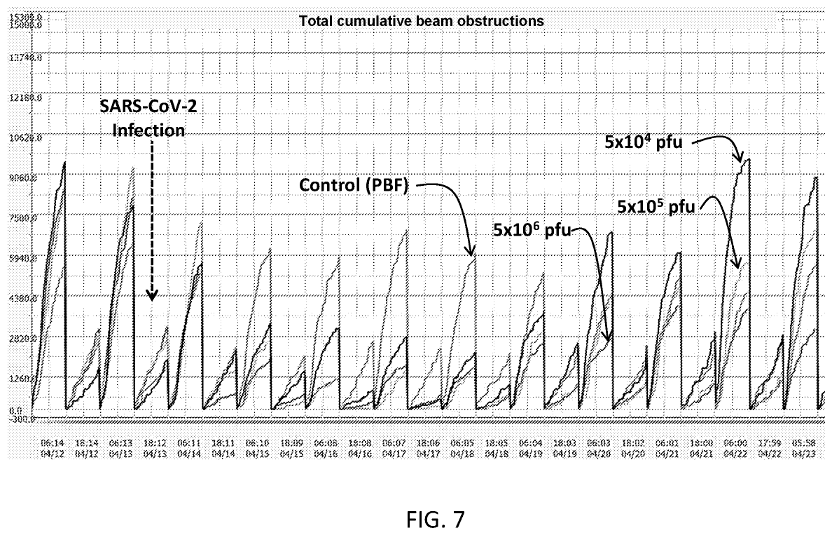

Drawing reference: FIG. 7
Number of cages monitored: 4
Animal type: Hamsters
Cage 1, Animal Group 1: Control group of 4 hamsters intranasally exposed to PBF (Virus growth medium without virus)
Cage 2, Animal Group 2: 4 Animals each injected with 5×10⁴ SARS-CoV-2 virions (pfu).
Cage 3, Animal Group 3: 4 Animals each injected with 5×10⁵ SARS-CoV-2 virions (pfu).
Cage 4, Animal Group 4: 4 Animals each injected with 5×10⁶ SARS-CoV-2 virions (pfu).

Description: The graphs as shown in FIG. 7 are cumulative beam obstructions by all animals combined in each cage. As shown, the cumulative activity of Group 1 can immediately be seen to be constant with circadian fluctuation with high activity during nighttime (5 pm-5 am) and low activity during daytime (5 am-5 pm). Groups 2, 3 and 4 show reduced activity as soon as 24 hours after SARS-CoV-2 infection, with return to baseline activity of group 2 (black line) infected with low viral dose (5×10⁴ pfu) 6 days post infection, and of group 3 (yellow line) infected with 5×10⁵ pfu after 10 days from viral infection. However, group 3 (blue line) that was infected with high viral load (5×10⁶ pfu) remains with relatively reduced circadian activity as a result of disease state.

Unless otherwise defined, all technical and scientific terms used herein have the same meaning as commonly understood by one of ordinary skill in the art. The materials, methods, and examples provided herein are illustrative only and not intended to be limiting.

Implementation of the method and system of the present disclosure may involve performing or completing certain selected tasks or steps manually, automatically, or a combination thereof. Moreover, according to actual instrumentation and equipment of preferred embodiments of the method and system of the present disclosure, several selected steps may be implemented by hardware (HW) or by software (SW) on any operating system of any firmware, or by a combination thereof. For example, as hardware, selected steps of the disclosure could be implemented as a chip or a circuit. As software or algorithm, selected steps of the disclosure could be implemented as a plurality of software instructions being executed by a computer using any suitable operating system. In any case, selected steps of the method and system of the disclosure could be described as being performed by a data processor, such as a computing device for executing a plurality of instructions.

As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Although the present disclosure is described with regard to a “computing device”, a “computer”, or “mobile device”, it should be noted that optionally any device featuring a data processor and the ability to execute one or more instructions may be described as a computing device, including but not limited to any type of personal computer (PC), a server, a distributed server, a virtual server, a cloud computing platform, a cellular telephone, an IP telephone, a smartphone, a smart watch or a PDA (personal digital assistant). Any two or more of such devices in communication with each other may optionally comprise a “network” or a “computer network”.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment or implementation are necessary in every embodiment or implementation of the invention. Further combinations of the above features and implementations are also considered to be within the scope of some embodiments or implementations of the invention.

While certain features of the described implementations have been illustrated as described herein, many modifications, substitutions, changes and equivalents will now occur to those skilled in the art. It should be understood that the embodiments in this disclosure are presented by way of example only, not limitation, and various changes in form and details may be made. Any portion of the apparatus, computer readable media, and/or methods described herein may be combined in any combination, except mutually exclusive combinations. The implementations described herein can include various combinations and/or sub-combinations of the functions, components and/or features of the different implementations described.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure.

What is claimed is:

1. A homecage monitoring system comprising:
a) a detection assembly including:
i. a single detector; and
ii. a mounting assembly configured for mounting of the single detector thereto and configured for attachment of the mounting assembly adjacent to a homecage to be monitored.

2. The system of claim 1, further comprising a controller in data communication with the single detector and adapted for collecting the output data from the single detector.

3. The system of claim 2, further comprising an analyzer in data communication with the controller, wherein the analyzer is a computing device.

4. The system of claim 1, wherein the single detector comprises a retroreflective sensor.

5. The system of claim 2, further comprising sensors in communication with the controller.

6. The system of claim 5, wherein the sensors are for one or more of: temperature, light, humidity, homecage pH, food level, water level, and animal play devices.

7. The system of claim 2, further comprising one or more pause buttons in communication with the controller, wherein the pause button is adapted for indicating the start and end of a period of interruption in animal monitoring to the controller.

8. The system of claim 1, wherein the mounting assembly is configured for retrofitting to an existing cage rack.

9. The system of claim 1, wherein the mounting assembly includes column clamps, a detector mount, and a backplane, wherein the single detector is mounted on the detector mount.

10. The system of claim 9 wherein the detector mount is slidably attached to the backplane such that the position of the detector mount can be adjusted.

11. The system of claim 9, wherein the detector is mounted on the detector mount such that the detector position can be adjusted.

12. The system of claim 9, wherein the column clamps are configured for adjusting to fit a horizontal distance between rack columns according to the cage rack dimensions.

13. The system of claim 2, wherein multiple detection assemblies are in communication with the controller.

14. The system of claim 13, wherein multiple controllers are in communication with the analyzer.

15. The system of claim 3, wherein the single detector provides an output signal indicating obstruction of a light beam emitted by the detector.

16. The system of claim 15, wherein the analyzer is adapted for collecting numbers of beam obstructions detected by the detectors.

17. The system of claim 16, wherein the numbers of beam obstructions are displayed on a user interface of the analyzer.

18. A method for monitoring animals in a homecage comprising:
a) providing the system of any one of claims 1-17 positioned opposite a homecage including the animals for monitoring; and
b) monitoring the detected beam breaks of the single detector to determine animal activity.

19. The method of claim 18, wherein pressing of the pause button results in a pause in monitoring or an indication of the time period of an interruption.

20. The method of claim 19, wherein data from the sensors is used for analysis of animal activity as detected.
